(19) United States
(12) Patent Application Publication
(10) Pub. No.: US 2005/0203231 A1
(43) Pub. Date: Sep. 15, 2005

(54) Polymer ceramic slip and method of manufacturing ceramic green bodies there therefrom

(75) Inventors: Daniel Halpert, Boca Raton, FL (US); Joe Arnold, Palm Beach Gardens, FL (US); Walter Guy Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc., Palm Beach Gardens, FL (US)

(21) Appl. No.: 10/998,127

(22) Filed: Nov. 29, 2004

Related U.S. Application Data
(60) Provisional application No. 60/525,927, filed on Nov. 29, 2003.
(60) Provisional application No. 60/572,613, filed on May 20, 2004.

(51) Int. Cl. C08K 3/10

(52) U.S. Cl. 524/413

(57) ABSTRACT

A polymer slip for producing a ceramic body is disclosed. The slip includes a polymer, surfactant, dispersant and about 50-70 volume % ceramic powder. The slip can be set in a closed mold. In another embodiment, the present invention relates to a method of manufacturing a green body. The method includes contacting a ceramic powder with a polymer to form a slip mixture, mixing the slip mixture, injecting the slip mixture in a mold and setting the mixture in the mold at a temperature of about 20-40° C. The slip mixture comprises about 50-65 volume % of the ceramic powder.

### CROSS-REFERENCE TO RELATED APPLICATIONS

The present application claims the benefit of U.S. Provisional Patent Application No. 60/525,927, filed Nov. 29, 2003 and U.S. Provisional Patent Application No. 60/572,613, filed May 20, 2004, both of which are incorporated herein by reference in their entirety for all purposes.

### BACKGROUND OF THE INVENTION

1. Field of the Invention

The present invention relates to polymer slips for forming ceramic green bodies, and to methods of manufacturing the same.

2. Related Art

Slip casting of ceramics is a known process in the manufacture of ceramic material. The process generally includes forming an aqueous or organic solvent based slip mixture of ceramic particles, a solvent, a binder, and other ingredients such as dispersants and surfactants. The ingredients are mixed to a pourable viscosity via a time intensive process, such as a rolling mill.

Slip casting molds are usually plaster or similar rigid materials that absorb the solvent from the slip to solidify it into a solid body. The molds have a very limited geometry, which limits the functionality of the resulting ceramic body. Molds made of rubber or silicone have come into use in recent years, but these molds require that the solvent be evaporated from an open surface or after molding the slip mixture. The evaporation process requires long time periods and frequently produces distorted products.

U.S. Pat. No. 4,978,643 discloses a method of forming green bodies using a solvent based slip mixture. The solvent is evaporated after molding the slip mixture by heating. Release of the solvent, however, can lead to cracking and deformation in the green body. U.S. Pat. No. 5,456,877 discloses another water-based slip mixture. No mention is made of how the water is removed without distorting the molded article. U.S. Pat. No. 6,228,299 B1 discloses additional water and other solvent based slip mixtures, which require an additional heating step to evaporate the solvent. U.S. Pat. No. 5,660,877 discloses a method of forming a liquid based slip mixture, which requires an additional step of freeze-drying the molded slip mixture to remove the liquid. The freeze-drying step is performed under vacuum for extended time periods to remove all the liquid.

What is needed is a slip mixture that can be set without distortion or large amounts of shrinkage, has high solids loading and can be formed to have microsized features.

### SUMMARY OF THE INVENTION

In one embodiment, the present invention relates to a polymer slip for producing a ceramic green body, comprising polymer, surfactant, dispersant and about 50-70 volume % ceramic powder, wherein the slip can be set in a mold.

In another embodiment, the present invention relates to a polymer slip for producing a ceramic green body, comprising about 2-5 wt % polymer, about 1-3 wt % dispersant, about 0.1-1.0 wt % surfactant and about 90-95 wt % piezoelectric ceramic powder, wherein the slip can be set in a closed mold at a temperature of about 20-40° C. and the slip has substantially no shrinkage upon setting.

In another embodiment, the present invention relates to a method of forming a net-shaped ceramic green body having microsized elements, comprising contacting a ceramic powder with a polymer and surfactant to form a slip mixture, mixing the slip mixture, injecting the slip mixture in a mold, and setting the mixture in the mold, wherein the slip mixture comprises about 50-70 volume % of the ceramic powder.

In another embodiment, the present invention relates to a net-shaped ceramic green body having microsized features, comprising surfactant, dispersant, polymer and about 50-70 vol % piezoelectric ceramic powder.

In another embodiment, the present invention relates to a two-part ceramic slip, comprising a first part comprising about 1-4 wt % epoxy part A, about 1-4 wt. % dispersant, about 0.1-0.3 wt. % surfactant and about 90-95 wt. % piezoelectric ceramic powder, and a second part comprising about 1-4 wt % epoxy part B, about 1-4 wt. % dispersant, about 0.1-0.4 wt. % surfactant and about 90-95 wt. % piezoelectric ceramic powder, whereby the first and second parts are stored separately prior to mixing to form a polymer ceramic slip mixture.

These and other embodiments, advantages and features will become readily apparent in view of the following detailed description of the invention.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a diagram of a polymer slip mixture, according to an embodiment of the present invention.

FIG. 2 shows a flowchart showing example steps for manufacturing a green body, according to an embodiment of the present invention.

FIG. 3A shows an illustration of a rectangular microsized structural feature, according to an embodiment of the present invention.

FIG. 3B shows an illustration of a circular microsized structural feature, according to an embodiment of the present invention.

FIG. 4A shows an illustration of an array of rectangular microsized structural features, according to an embodiment of the present invention.

FIG. 4B shows an illustration of an array of circular microsized structural features, according to an embodiment of the present invention.

### DETAILED DESCRIPTION OF THE INVENTION

“Polymer slip” is used herein to refer to the composition comprising the ceramic powder that can be molded to form a molded slip mixture. “Green body” is used herein to mean the molded article that results from molding and setting the polymer slip. “Sintered ceramic body” is used herein to refer to the product of sintering a green body.

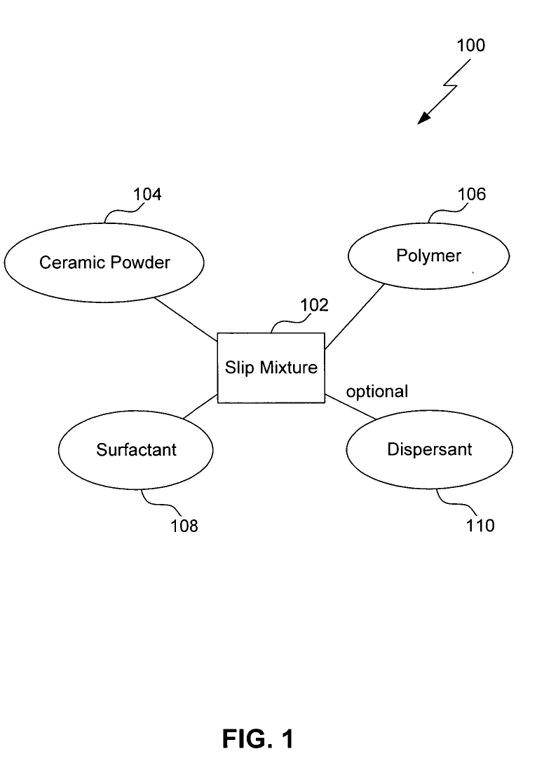

In one embodiment, the present invention relates to a polymer slip for producing a ceramic body. FIG. 1 shows a diagram 100 of polymer slip mixture 102. Polymer slip mixture 102 comprises ceramic powder 104, polymer 106, surfactant 108 and optionally comprises dispersant 110.

Ceramic powders for use in present invention include any piezoelectric ceramic powder that when molded and fired into a sintered ceramic body exhibit piezoelectric properties. Specific examples include, but are not limited to, lead zirconate titanate (PZT), lead niobium titanate (PNT), lead scandium niobium titanate (PSNT) and mixtures thereof. Ceramic powders for use in the present invention have small mean particle size. Small mean particle size leads to dense ceramic structures with good physical and mechanical properties. In one example, ceramic powders have mean particle size of about 0.05-25 μm. In an alternative example, ceramic powders have mean particle size of about 0.25-6 μm. These dimensions are illustrative. Smaller and larger particle sizes can be used.

The amount of ceramic powder in the slip mixture can vary depending on the desired final properties of the slip mixture, green body and sintered ceramic body. Increasing the amount of ceramic powder in the slip reduces the sinter shrinkage and may increase the density of the resulting ceramic body. More dense bodies have better physical and mechanical properties, such as mechanical strength. However, the processability of the slip mixture is adversely affected as the volume and/or weight fraction of ceramic powder increases. Specifically, the slip mixture becomes more powdery, less pourable, and cannot be molded into microsized structural elements. Traditional slip mixtures use excess liquids to make the slip mixture pourable and moldable, which must be removed in additional steps and result in cure shrinkage. Slip mixtures of the present invention, however, comprise a high is adversely affected as the volume and/or weight fraction of ceramic powder increases. Specifically, the slip mixture becomes more powdery, less pourable, and cannot be molded into microsized structural elements. Traditional slip mixtures use excess liquids to make the slip mixture pourable and moldable, which must be removed in additional steps and result in cure shrinkage. Slip mixtures of the present invention, however, comprise a high volume percent (vol %) and/or weight percent (wt %) of ceramic powder, resulting in dense ceramic bodies, without using excess liquids or solvents to render the slip pourable and moldable. For example, the slip mixture can comprise about 80-98 wt % of ceramic powder. Alternatively, the slip mixture comprises about 90-95 wt % ceramic powder. Alternatively, the slip mixture comprises about 50-70 vol % ceramic powder.

Polymer slip mixtures of the present invention comprise low wt. % of polymer. For example, the polymer slip can comprise 1-5 wt. % polymer. Polymers for use in the present invention include any polymers that bind the ceramic powders, are moldable as part of the slip mixture and form slip mixtures having viscosities low enough to be flowable, pourable or injectible. The term “polymer” includes polymer precursors, pre-polymers, and uncrosslinked polymers mixed with cross-linking agents. In one example, the polymer is a thermosetting polymer. Particular examples of polymers include, but are not limited to, polyesters, polyurethanes, silicone rubbers and epoxy polymers. A preferred polymer is low viscosity epoxy polymer.

The phrase “epoxy polymer” is used herein to refer to uncured epoxy precursors, mixed epoxy precursors and the finished, cured or cross-linked epoxy polymer. Epoxy polymers for use in the present invention include, but are not limited to, two-part epoxy precursors, three-part epoxy precursors, or epoxy precursors having more than three parts. One example of a two part epoxy precursor includes, but is not limited to, a precursor having two or more amine functional groups and another part having two or more epoxide functional groups. Epoxy resins are well known to one of ordinary skill in the art. Specific examples of epoxy polymers include D.E.R. 300 and 600 series epoxy resins (available from Dow Chemicals, Inc.) and the polymer that results from a first part RBC-3200 A epoxy resin and a second hardener part RBC-3200 B120 (available from RBC Industries, Inc.).

Preferably, the cure or set time for a thermosetting polymer used, for example, an epoxy polymer, is long enough to allow mixing of the polymer slip mixture and injection into the mold before the thermosetting polymer hardens. For example, the set time is about 10 minutes to about 48 hours, preferably about 30 minutes to about 3 hours.

The use of surfactants and dispersants in ceramics manufacturing is well known to one of ordinary skill in the art. Dispersants and surfactants, and optionally other additives, are used to control the stability, wettability, flowability, viscosity and other properties of the polymer slip mixture. Any surfactant that is compatible with organic polymers can be used. Preferably, the surfactant lowers the surface tension of the polymer and is capable of stabilizing the slip mixture and/or facilitating the formation and molding of the slip mixture. Specific examples of surfactants for use in the present invention include, but are not limited to, Dow Corning 57 surfactant, Fluorad™ FC-4430 surfactant, Fluorad™ FC-4432 surfactant, Surfonic PE-1198 surfactant and KEN-REACT® KR-55 surfactant.

Any dispersant capable of facilitating the dispersion of the ceramic powder into the slip mixture and/or facilitating the formation and molding of the slip mixture can be used in the present invention. Specific examples of dispersants for use in the present invention include, but are not limited to, DYSPERBYK® 110 dispersant and Dequest 2010 dispersant.

Upon formation, the slip mixture of the present invention comprises high vol % and/or wt % of ceramic powder, and preferably, comprises no excess liquid and no solvent. Slip mixtures of the present invention are pourable and flowable, having viscosities low enough for low-pressure injection molding. In one example, the slip mixtures have viscosities of about 1000-2000 centapoise (cps) at about 20-30° C. In another example, the slip mixtures can be injection molded at pressures of about 5-100 p.s.i. and/or at temperatures of about 20-40° C. Because the slip mixtures comprise little to no excess solvent or liquid that requires evaporation to harden the slip, slip mixtures of the present invention have little to substantially no shrinkage upon setting.

Because slip mixtures of the present invention have little shrinkage, precision molding of net-shaped green bodies having microsized elements and/or features is possible. “Net-shaped” is used herein to mean that green bodies of the present invention have high-quality, microsized elements or features upon molding, and no additional machining or processing to achieve high quality, microsized features or elements is required. Slip mixtures of the present invention have substantially no distortion upon setting. The phrase “substantially no distortion” is used herein to mean flat surfaces of the molded slip mixture remain flat upon setting, hardening and/or curing the molded slip mixture to form the green body, and the surfaces of the green body are smooth and essentially free of defects larger than about the grain size of the ceramic powder. Defects include, but are not limited to, holes, bubbles, cracks and the like. The slip mixtures, therefore, can be molded to net-shaped green bodies, have high quality microsized structural elements, and the green bodies can have overall large dimensions.

The combination of microsized elements and large green bodies greatly expands the applicability of the molded articles. For example, slip mixtures of the present invention can be used to form ceramic bodies for use as piezoelectric sensors for a wide range of applications, including, but not limited to, biometric data collection devices, sound dampening devices, or other passive or active piezoelectric devices. Biometric data collection devices can include, but are not limited to, piezoelectric identification devices that capture images of fingerprints as described, for example, in International Patent Appl. No. PCT/US01/09187, incorporated herein by reference in its entirety for all purposes.

In another embodiment, the present invention relates to a polymer slip for producing a ceramic green body, comprising about 2-5 wt % polymer, about 1-3 wt % dispersant, about 0.1-1.0 wt % surfactant and about 90-95 wt % piezoelectric ceramic powder, wherein said slip can be set in a closed mold at a temperature of about 20-40° C. and said slip has substantially no shrinkage upon setting.

Polymers for use in the invention that have limited shelf life can add complexity to large scale manufacturing, as the slip mixture has a limited shelf life before setting after it is mixed. To facilitate the large scale manufacturing of green bodies, two-part slip mixture powders can be formulated that greatly increased shelf-life. For example, a two part epoxy polymer for use in the slip mixtures of the present invention can be formulated such that the two components are mixed with surfactant, dispersant, and ceramic powder separately, and stored separately. These epoxy “A” and “B” components are not pot life limited, and can be stored for long periods of time, and used when needed. The epoxy A and B components can be mixed in specific ratios to achieve the desired slip mixture. Mixing the two components together produces a slip mixture that can then be injection molded like other slip mixtures of the present invention.

In another embodiment, therefore, the present invention relates to a two-part ceramic slip, which includes a first part comprising about 1-4 wt % epoxy part A, about 1-4 wt. % dispersant, about 0.1-0.3 wt. % surfactant and about 90-95 wt. % piezoelectric ceramic powder, and a second part comprising about 1-4 wt % epoxy part B, about 1-4 wt. % dispersant, about 0.1-0.4 wt. % surfactant and about 90-95 wt. % piezoelectric ceramic powder, whereby the first and second parts are stored separately prior to mixing to form a polymer ceramic slip mixture.

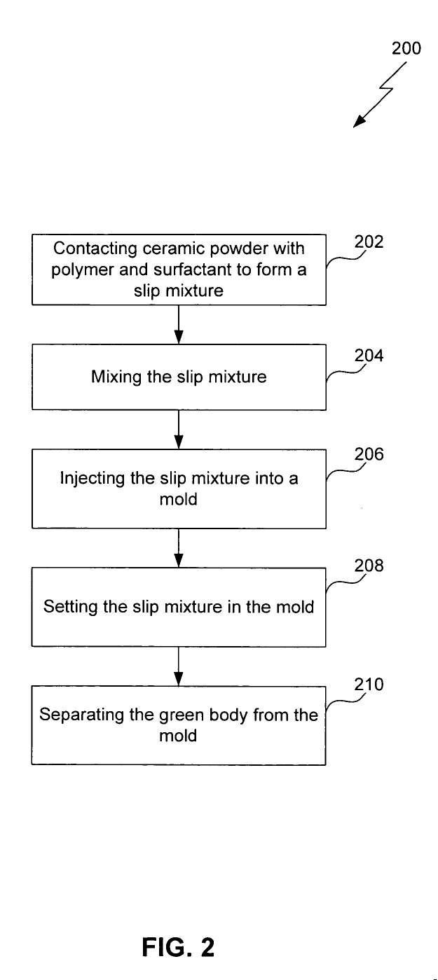

In another embodiment, the present invention relates to a method of manufacturing a net-shaped green body having microsized elements or features. For example, FIG. 2 shows a flowchart 200 showing example steps for manufacturing a green body, according to an embodiment of the present invention. Flowchart 200 begins with step 202. In step 202, a ceramic powder is contacted with a polymer and surfactant to form a slip mixture. The slip mixture optionally further comprises dispersant. In step 204, the slip mixture is mixed. In step 206, the slip mixture is injected into a mold. In step 208, the slip mixture is set in the mold. In step 210, the green body is separated from the mold.

In step 204, the polymer slip mixture is mixed using any method known to one of skill in the relevant art. In one example, the slip mixture is mixed using a kinetic shear mixer. The mixture is optionally held under a vacuum during mixing to remove any trapped gases in the slip mixture. For instance, the polymer slip mixture can be inserted into and mixed in a kinetic shear mixer under vacuum, as described in the mutually-owned, co-pending patent application entitled “Kinetic Vacuum/Shear Mixer” (Attorney Docket No. 1823.1250000), incorporated herein by reference in its entirety for all purposes. The mixture is mixed for a time sufficient to produce a fully mixed polymer slip mixture, and the mixing is stopped before the mixture sets and the polymer hardens. Preferably, the slip mixture is mixed under vacuum for a time of about 5 minutes to 1 hour.

In step 206, the slip mixture is injected into a closed mold. Any method known to one of ordinary skill in the relevant art can be used to inject or transfer the slip mixture into the mold. For example, the mold is first evacuated under reduced pressure by applying a vacuum to the mold. Second, the slip mixture is injected into the mold using pressure. Pressures for use in step 206 include any pressure capable of injecting the mixture into the mold. In one example, a pressure of about 5-100 p.s.i. at a temperature of about 20-40° C. is used. In another example, the mixture can be injected directly from a kinetic shear mixer to one or more molds using pressure.

The molds used for molding the slip mixture and forming the green body can be any mold capable of forming and releasing microsized structural elements in the green body. The slip mixture can be molded in a closed mold. Therefore, the molds used for molding the slip mixture can be open or closed molds. The phrase “closed mold” is used herein to refer to a sealable mold, which has little or no ventilation, or allows essentially no evaporation of solvents, liquids, gases, vapors or the like from the slip mixture during the time it takes to mold and set the slip mixture. The closed molds of the present invention optionally allow for the absorption of solvents, liquids, gases, vapors or the like into the mold body. Preferably, there is no absorption into the body of the closed mold. The phrase “open mold” is used herein to refer to an unsealed mold, which has ventilation, or allows for evaporation of solvents, liquids, gases, vapors or the like from the slip mixture. The open molds of the present invention optionally allow for the absorption of solvents, liquids, gases, vapors or the like into the mold body. Preferably, the slips of the present invention do not require or utilize surface evaporation or mold absorption.

Molds of the present invention can be made of any material capable of forming microsized structural elements in the slip mixture and green body, and releasing the molded microsized elements without damage. Examples of materials for use as molds include, but are not limited to, plastics and rubbers. Specific examples of materials include, but are not limited to, low durometer (hardness of less than about 40 A) thermoset polyurethanes and silicones.

Referring back to FIG. 2, in step 208, the molded slip mixture is set. Any method known to one of ordinary skill in the art can be used to set the molded slip mixture. In one specific example, the molded slip mixture is allowed to set at a temperature of about 20-40° C. for a time sufficient to set the mixture. Preferably, the time is about 10 minutes to about 6 hours. Alternatively, the molded slip mixture is set in a two stage process to form the green body. First, the molded slip mixture is set at a temperature of about 20-40° C., in the mold, for about 10 minutes to about 6 hours. Second, the molded slip mixture is heated to a temperature sufficient to complete the setting of the mixture. For example, the slip mixture is heated to a temperature of about 40-75° C., in the mold, for about 10 minutes to about 6 hours.

In step 210, the green body is separated from the mold. Any method of separating known to one of ordinary skill in the art can be used to separate the mold from the green body. Examples of methods include, but are not limited to, peeling or lifting the molds off the green bodies. Preferably, the separation is done so that few or none of the microsized structural elements are damaged during separation.

In another embodiment, the present invention relates to a net-shaped ceramic green body having microsized features comprising surfactant, dispersant, polymer and about 50-70 vol % piezoelectric ceramic powder.

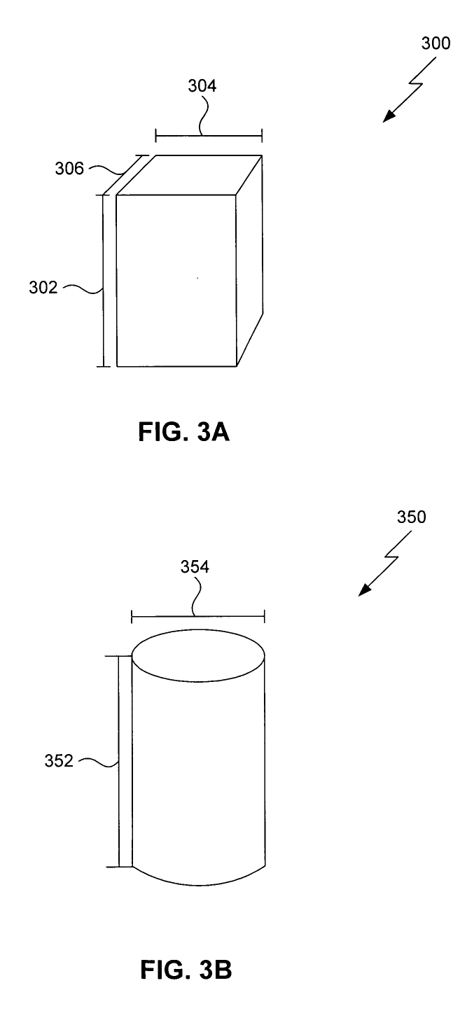

Green bodies manufactured in accordance with the present invention have microsized structural elements. For example, green bodies can have circular, square and rectangular elements. FIGS. 3A and 3B show two exemplary elements that can be formed in the green body upon molding and setting the slip mixture. FIG. 3A shows a diagram of a rectangular element 300, having height 302 and widths 304 and 306. FIG. 3B shows a diagram of a circular element 350, having height 352 and diameter 354. Elements 300 and 350 have heights 302 and 352, respectively, of about 100-1200 μm, alternatively about 250-800 μm. Element 300 has widths 304 and 306 of about 20-500 μm, alternatively about 40-120 μm. Element 350 has diameter 354 of about 20-500 μm, alternatively about 40-120 μm.

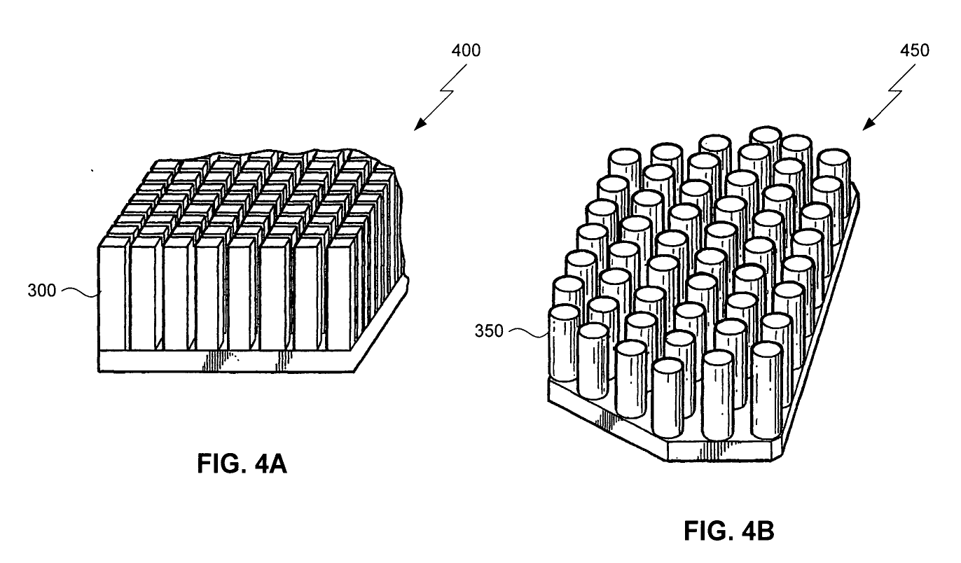

Green bodies of the present invention can be any shape. In one specific example, the green bodies are square, in which the width and length of the green body is about equal, having dimensions of about 0.25-12 inches on both width and length. The green bodies can be formed with arrays of structural elements. FIG. 4A shows a diagram of an array 400, comprising a plurality of rectangular elements 300. FIG. 4B shows a diagram of an array 450, comprising a plurality of circular elements 350. Arrays of elements can be formed in the green bodies with specific numbers of elements in each array. The center-center distance of the elements in the green bodies is about 50-150 μm.

Specific examples of green bodies of the present invention include, but are not limited to, a square green body having width and length of about 26 mm, height of about 1-2 mm, and comprising about 532 rectangular elements along the width and about 532 rectangular elements along the length of the array. The elements have heights of about 325-375 μm, widths of about 35-45 μm, and the center-to-center distance between elements is about 45-55 μm.

The following examples are illustrative, but not limiting, of the method of the present invention. Modifications and adaptations of the parameters of the invention in response to issues normally encountered in manufacturing will be apparent to those skilled in the art and are within the spirit and scope of the invention.

### EXAMPLES

### Example 1

In this example, a slip mixture was formulated according to the amounts shown in Table 1.

TABLE 1
Polymer slip formulation

| MATERIAL | AMOUNT (g) |
|---|---|
| A epoxy | 0.155 |
| B epoxy | 0.047 |
| Dispersant | 0.152 |
| Surfactant | 0.020 |
| PZT powder (1 μm, 7.8 g/ml) | 5.070 |
| TOTAL | 5.444 |

The formulation was then mixed in a kinetic shear mixer, under vacuum, for a period of 15 minutes. The mixed polymer slip mixture was then injected into a silicone rubber mold having features for forming microsized structural elements in the molded polymer slip. The molded slip mixture was cured for 2 hours at constant temperature of about 25° C. During the cure, the molds were held under increased pressure of about 1-10 atmospheres to maintain the shape and volume of the molded slip mixture. Upon achieving dimensional set, the pressure was released and the molded slip mixture was further cured to a temperature necessary to fully cure the epoxy polymer. The silicone molds were then removed. The resulting green body had the desired array of circular structural elements or rods, whose ends formed a smooth plane, and backing plate, a parallel to the rod ends, which had a smooth and flat surface. This example shows that the slip mixtures of the present invention can be mixed, molded, cured and formed into green bodies with microsized structural elements, without distortion during manufacturing.

### Example 2

In this example, large volumes of slip mixture for production were mixed as epoxy A and epoxy B components, according to the formulations in Table 2.

TABLE 2
TWO-PART POLYMER SLIP FORMULATION

| PART A | | PART B | |
|---|---|---|---|
| MATERIAL | AMOUNT (g) | MATERIAL | AMOUNT (g) |
| A epoxy | 0.119 | B epoxy | 0.047 |
| Dispersant | 0.117 | Dispersant | 0.035 |
| Surfactant | 0.015 | Surfactant | 0.005 |
| PZT powder | 3.899 | PZT powder | 1.171 |
| (1 μm, 7.8 g/ml) | | (1 μm, 7.8 g/ml) | |
| Total part A | 4.150 | Total part B | 1.258 |

| | |
|---|---|
| Total Formulation | 5.408 |
| (Part A + Part B) | |

The Part A and Part B components were stored in separate containers. Therefore, the components were not shelf-life limited. The parts were mixed together in a ratio of Part A:Part B of about 3:1. The polymer slip mixture was then mixed, molded and cured as in Example 1. This example shows that large batches of slip powder can be produced and the slip mixture is not limited by shelf-life. This procedure helps facilitate large scale manufacturing of green bodies and their corresponding ceramic bodies.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A polymer slip for producing a ceramic green body, comprising polymer, surfactant, dispersant and about 50-70 volume % ceramic powder, wherein said slip can be set in a mold.

2. The slip of claim 1, wherein said mold is a closed mold.

3. The slip of claim 1, wherein said slip can be set in a mold at a temperature of about 20-40° C.

4. The slip of claim 1, wherein said slip is solvent free.

5. The slip of claim 1, wherein said slip has substantially no shrinkage upon setting.

6. The slip of claim 5, wherein said slip has substantially no distortion upon setting.

7. The slip of claim 1, wherein said slip can be injection molded at pressures of about 5-100 p.s.i.

8. The slip of claim 7, wherein said slip can be injection molded at a temperature of about 20-40° C.

9. The slip of claim 1, wherein said slip has viscosity of about 1000-2000 centipoise (cps)

10. The slip of claim 1, wherein said slip can be molded to form net shaped green bodies having microsized features.

11. The slip of claim 10, wherein said microsized features are rectangular-shaped features and have height of about 325-350 μm, widths of about 35-45 μm and center-to-center spacing between features of about 45-55 μm.

12. The slip of claim 1, wherein said polymer is epoxy, polyurethane, polyester or silicone.

13. The slip of claim 12, wherein said polymer is a two-part epoxy polymer.

14. The slip of claim 1, comprising about 1-5 wt % of said polymer.

15. The slip of claim 1, where said ceramic powder is piezoelectric ceramic powder.

16. The slip of claim 1, wherein said ceramic powder is selected from the group consisting of lead zirconate titanate (PZT), lead niobium titanate (PNT), lead scandium niobium titanate (PSNT) and mixtures thereof.

17. The slip of claim 15, wherein said ceramic powder has mean particle size of about 0.05-6 μm.

18. A polymer slip for producing a ceramic green body, comprising about 2-5 wt % polymer, about 1-3 wt % dispersant, about 0.1-1.0 wt % surfactant and about 90-95 wt % piezoelectric ceramic powder, wherein said slip can be set in a closed mold at a temperature of about 20-40° C. and said slip has substantially no shrinkage upon setting.

19. The slip of claim 18, wherein said ceramic green body is net shaped ceramic green body having microsized features.

20. The slip of claim 18, wherein said slip can be injection molded at a temperature of about 20-40° C. and a pressure of about 5-100 p.s.i.

21. A method of manufacturing a net-shaped ceramic green body having microsized elements, comprising:
contacting a ceramic powder with a polymer and surfactant to form a slip mixture;
mixing said slip mixture;
injecting said slip mixture in a mold; and
setting said mixture in said mold;
wherein said slip mixture comprises about 50-70 volume % of said ceramic powder.

22. The method of claim 21, wherein said mold is a closed mold.

23. The method of claim 21, wherein said slip mixture has substantially no shrinkage upon setting in said mold.

24. The method of claim 21, wherein said slip mixture further comprises dispersant.

25. The method of claim 21, wherein said ceramic powder is piezoelectric ceramic powder.

26. The method of claim 25, wherein said piezoelectric ceramic powder is selected from the group consisting of lead zirconate titanate (PZT), lead niobium titanate (PNT), lead scandium niobium titanate (PSNT) and mixtures thereof.

27. The method of claim 25, wherein said piezoelectric ceramic powder has mean particle size of about 0.05-6 μm.

28. The method of claim 21, wherein said injecting step comprises:
injecting said slip mixture in a closed mold at a pressure of about 5-100 p.s.i.

29. The method of claim 28, wherein said injecting step further comprises:
injecting said slip mixture in a closed mold at a temperature of about 20-40° C.

30. The method of claim 21, wherein said setting step comprises:
setting said mixture in said closed mold at a temperature of about 20-40° C.

31. The method of claim 21, wherein said microsized elements are rectangular-shaped features and have height of about 325-350 μm, widths of about 35-45 μm and center-to-center spacing between features of about 45-55 μm.

32. The method of claim 21, wherein said microsized elements form a square array of elements having 532 features on the width and length.

33. The method of claim 21, wherein said closed mold is a silicone mold.

34. The method of claim 21, further comprising after said step of setting said mixture:
curing said mixture in said closed mold at a temperature of about 40-80 oc.

35. A ceramic green body produced by the process of claim 21.

36. The green body of claim 35, comprising a plurality of sensing elements having height of about 250-350 μm, width of about 40-50 μm and about 10 degrees in pitch.

37. The green body of claim 36, wherein said plurality of sensing elements are circular or rectangular sensing elements.

38. A net-shaped ceramic green body having microsized features comprising surfactant, dispersant, polymer and about 50-70 vol % piezoelectric ceramic powder.

39. The green body of claim 38, comprising about 1-5 wt % polymer.

40. The green body of claim 38, wherein said polymer is epoxy polymer.

41. The green body of claim 38, wherein said microsized features are rectangular or circular sensing elements having height of about 250-350 μm, width of about 40-50 μm and center-to-center distance between the elements of about 50-150 μm.

42. A two-part ceramic slip, comprising:
a first part comprising about 1-4 wt % epoxy part A, about 1-4 wt. % dispersant, about 0.1-0.3 wt. % surfactant and about 90-95 wt. % piezoelectric ceramic powder; and
a second part comprising about 1-4 wt % epoxy part B, about 1-4 wt. % dispersant, about 0.1-0.4 wt. % surfactant and about 90-95 wt. % piezoelectric ceramic powder;
whereby said first and second parts are stored separately prior to mixing to form a polymer ceramic slip mixture.
